(19) United States
(12) Patent Application Publication
(10) Pub. No.: US 2012/0232968 A1
(43) Pub. Date: Sep. 13, 2012

(54) REAL-TIME VIDEO IMAGE ANALYSIS FOR AN APPROPRIATE PAYMENT ACCOUNT

(75) Inventors: Matthew A. Calman, Charlotte, NC (US); Erik Stephen Ross, Charlotte, NC (US); Alfred Hamilton, Charlotte, NC (US)

(73) Assignee: BANK OF AMERICA CORPORATION, Charlotte, NC (US)

(21) Appl. No.: 13/342,046

(22) Filed: Jan. 1, 2012

Related U.S. Application Data
(60) Provisional application No. 61/450,213, filed on Mar. 8, 2011.
(60) Provisional application No. 61/478,402, filed on Apr. 22, 2011.

(51) Int. Cl. G06Q 30/02

(52) U.S. Cl. 705/14.4

(57) ABSTRACT

System, method, and computer program product are provided for using real-time video analysis, such as augmented reality to assist the user of mobile devices with selecting an appropriate payment account for a transaction. Through the use of real-time vision object recognition objects, logos, artwork, products, locations, and other features that can be recognized in the real-time video stream can be matched to data associated with such to assist the user with selecting an appropriate payment account for a transaction. The recommended appropriate payment account is based on the type of transaction, the payment accounts available to the user, financial institution considerations, and financial plans of the user. This invention allows a user to make a purchase at a point-of-sale and have confidence that the transaction will be implemented to the payment account that provides the best promotional benefits for the user based on the user's individual needs.

### CLAIM OF PRIORITY UNDER 35 U.S.C. §119

This Non-provisional Patent Application claims priority to U.S. Provisional Patent Application Ser. No. 61/450,213, filed Mar. 8, 2011, entitled “Real-Time Video Image Analysis Applications for Commerce Activity,” and U.S. Provisional Patent Application Ser. No. 61/478,402 titled “Real-Time Video Image Analysis for an Appropriate Payment Account” filed on Apr. 22, 2011, assigned to the assignee hereof and hereby expressly incorporated by reference herein.

### BACKGROUND

Even with advances in technology, knowing the best payment option is difficult to determine for a user. This is largely due to users having so many payment options to select from, all with different promotions. A user may not know the promotions associated with his payment options because the promotions may change at any instant, few or no merchants advertise promotions (except for maybe the merchant's own accounts), the promotions may include purchase restrictions that limit the benefits at different times, on different products, or at different merchants, etc. Therefore, the user often selects a payment option, from the variety of payment options, and enters the transaction with little or no thought as to which payment options provide the best promotions as they relate to the goals he wishes to achieve.

Current handheld mobile devices, such as smart phones or the like, have the functionality to allow there use for a myriad of day to day transactions, such as paying for a cup of coffee or providing a boarding pass for a flight. These technological advances combine multiple technologies into a handheld mobile device to provide a user with a large number of capabilities. For example, many smart phones are equipped with significant processing power, sophisticated multi-tasking operating systems, and high-bandwidth Internet connection capabilities. Moreover, such devices often have additional features that are increasingly more common and standardized. Such features include, but are not limited to, location-determining devices, such as Global Positioning System (GPS) devices; sensor devices, such as accelerometers; and high-resolution video cameras.

As the hardware capabilities of such mobile devices have increased, so too have the applications (i.e., software) that rely on the hardware advances. One such example of innovative software is a category known as augmented reality (“AR”), or more generally referred to as mediated reality. One such example of an AR presentment application platform is Layar® available from Layar, Amsterdam, the Netherlands. The Layar platform technology analyzes location data, compass direction data, and the like in combination with information related to the objects, locations or the like in the video stream to create browse-able “hot-spots” or “tags” that are superimposed on the mobile device display, resulting in an experience described as “reality browsing”.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing apparatuses (e.g., a system, computer program product and/or other devices) and methods for using real-time video analysis, such as AR or the like to assist the user of mobile devices with determining an appropriate payment account, which allows a user to participates in a financial transaction where an appropriate payment account is recommended to the user based on the transaction, the types of payment accounts available to the user, the user's financial plan, and financial institution considerations.

Using real-time video analysis, such as augmented reality or the like may provide the user of mobile device an appropriate payment account recommendation. Through the use of real-time vision object recognition, objects, logos, artwork, products, locations and other features that can be recognized in the real-time video stream can be matched to data associated with those objects, logos, artwork, products, locations, or other features to assist the user with determining the appropriate payment option when contemplating a transaction. In some embodiments, the data that is matched to the images in the real-time video stream is specific to financial institutions, such as user financial behavior history, user purchasing power, transaction history, and the like. In this regard, many of the embodiments herein disclosed leverage financial institution data, which is uniquely specific to financial institutions, in providing information to mobile device users in connection with real-time video stream analysis.

In some embodiments, the data that is matched to the images in the real-time video stream is specific to transactions a user may make. For example, a user may provide an image in the real-time video stream of a vehicle that the user may purchase. In some embodiments, the data that is matched to the images in the real-time video stream is specific to financial institutions, such as user financial behavior history, user purchase power, transaction history, and/or the like. In this way, many of the embodiments herein disclosed leverage financial institution data, which is uniquely specific to financial institution, in providing information to mobile device users in connection with real-time video stream analysis.

One or more indicators are presented on the display of the mobile device in conjunction with the real-time video stream. Each of the indicators corresponds with an image determined to be a product or potential transaction. The indicator may take various forms, such as a display of a tag, a highlighted area, a hot-spot, and/or the like. In some embodiments, the indicator is a selectable indicator, such that the user may select (e.g., click-on, hover-over, touch the display, provide a voice command, etc.) the product or indicator to provide display of specific information related to the product, including for instance the recommended appropriate payment accounts and/or the budget impact for the user. In other embodiments, the indicator itself may provide the information or a portion of the information. For example, a user may wish to purchase a television; the user may use real-time vision object recognition to recognize that the television within an isle at a retail store. The real-time vision object recognition may consider the located at a specific retail store, the characteristics of the television such as brand, quality, etc., and price of the television. The user may select the indicator. The selected indicator may display a recommended appropriate payment account for the purchase of the television to the user based on several criteria. These criteria may include, but are not limited to the type of transaction, the types of payment accounts available to the user, the user's financial plan, and financial institution considerations.

Along with the recommended appropriate payment account, the display of the real-time video stream on a mobile device may also provide the user with special offers, financing, budget impact if the user purchases the product, true cost of credit, etc. Special offers may be in the form of a discount, coupon, etc. that may expire within a predetermined amount of time or may be available to the user at any time he wishes to make a transaction. The special offers may also be contingent on opening accounts or other lines of business with the financial institution, independent of the transaction. The financial institution may provide the user real-time approval for loans or other financing options. For example, a user may wish to purchase a vehicle; he may use the real-time vision object recognition to identify the vehicle. In turn, the recommended appropriate payment account may be displayed to him along with a real-time loan approval to purchase the vehicle. The display may also provide a detailed indication of the impact a purchase would make on the user's budget. The display may also provide the true cost of credit or how long it will take the user to pay off the purchase or the total cost of the purchase depending on the user's financing for the transaction.

Further, the display of the real-time video stream on a mobile device may also provide the user with a direct video or audio conference with the user's financial advisor. In this way, the user may be provided instant advisement from his financial advisor for advice when purchasing major purchases or when the user is facing significant financial decisions.

Embodiments of the present invention provide an appropriate payment account recommendation to a user for a transaction the user may make. The appropriate payment account recommendation may be based on several criteria, including the transaction, the types of payment accounts available to the user, the user's financial plan, and/or financial institution considerations. The criteria are compared to information the system receives from a real-time video stream of a product in the display environment. A selection is then made by the system based off the information from the real-time video stream in correlation with the criteria. Selecting the appropriate payment account for the user may involve reviewing criteria relating to the purchase and selecting a payment account that best fits the criteria.

The transaction may be a type of purchase made at a plurality of merchants, online or offline, over the phone, at a plurality of point of sale systems, etc., and purchase may be made by the user using any type of payment device of a plurality of types of payment devices or choices available to the user.

The types of payment accounts available to the user may include any form of payment a customer may use to complete a transaction. These forms of payments may include, but are not limited to cash, check, credit cards, debit cards, retailer cards, stored value cards, mobile payment devices, virtual currency, and/or a plurality of lines of credit. In some embodiments, the types of forms of payments available to the user may be determined by accessing financial institution database and/or accessing other financial institutions, such as for example the financial institution of the merchant. In other embodiments, the types of payment forms available to the user may be determined through manually inputted information by the user.

The financial plans of the user may aid in determining a payment account recommendation for a transaction. Financial plans of a user may include financial goals, payment strategies, and personal planning. The financial goals of the user may include savings goals, such as saving for a child's college, investments, saving to reach a specific amount, saving to purchase a specific product, retirement savings goals, etc. The payment strategies of the user may include loan repayment (e.g., student loan repayment, car loan repayment, etc.), paying off credit card debt (e.g., paying off one credit card with higher interest rates faster than other debt), or mortgage repayment. Personal planning may also be used to determine the payment account for a transaction. Personal planning may include vacation planning, job loss planning, emergency planning, social networking data, and tax planning. For example, if the user indicates that he is planning a vacation, the system may direct the recommended appropriate payment account for a transaction to be a credit card with frequent flyer miles. Job loss planning allows the user to direct the system to recommend appropriate payment account for a transaction to maximize finances in case of unemployment. Emergency planning allows the user to direct the system recommend appropriate payment account for a transaction to accounts to address an emergency situation. Tax planning allows the user to direct the system to recommend appropriate payment account for a transaction to accounts to maximize tax planning strategies set by the user. In some embodiments, the financial plan may be created by accessing a financial institution server. In some embodiments, the financial plan may be created by user input via an interface. In some embodiments, the data within the financial plan may be ranked in order of importance for the user.

In some embodiments, financial institution considerations may be used to determine an appropriate payment account recommendation for a transaction. Financial institution considerations may include user transaction history, status of payment accounts, the transaction's impact on the user's budget, and/or the true cost of credit for the transaction. The true cost of credit may be the sum of the transaction fees, interest charges over a projected payback period, and/or the opportunity costs for the transaction. User transaction history may include a review of previous transaction requests from the same merchant to determine the payment account the user historically uses in that instance. For example, if a user always uses a specific credit card for all purchases at a grocery store, the financial institution server will recognize this historically used credit card and recommend applying the purchase from the grocery store to that card. A status update of payment accounts may allow, prior to applying the transaction request to a specific payment account, the financial institution server to access the selected account to ensure funds are available to continue processing the transaction. Status of payment accounts may ensure the credit limit for an account has not yet been reached. Financial institution considerations may also include the impact that purchasing the product may have on the user's budget. For example, a user may set a budgeting goal of saving 10,000 dollars over a six month period. If the user wishes to purchase a television and the purchase would keep the user from reaching his savings goals within the six month period, a notification might be sent. In some embodiments, financial institution considerations may be created by accessing the financial institution server.

Embodiments of the invention relate to systems, methods, and computer program products for providing a recommendation of an appropriate payment account comprising: receiving information about a plurality of payment accounts available to a user; determining promotions associated with each of the plurality of payment accounts, wherein the promotions are for purchases of products using the payment account; identifying one or more products proximate in location to a mobile device; determining the appropriate payment account for use in payment for the identified products, wherein the appropriate payment account is based at least in part on the determined promotions associated with each of the plurality of payment accounts, wherein the appropriate payment account provides the most beneficial promotion to the user at that time for the purchase of the one or more products; and presenting, via a mobile device, an indicator associated with the product, wherein the indication provides a payment account recommendation, wherein the payment account recommendation is the determined appropriate payment account.

In some embodiments, identifying one or more products further comprises capturing, via the mobile device, images of the one or more products. Capturing images further comprises implementing, via a computer device processor, object recognition processing to identify one or more images that correspond to one or more products. Identifying one or more products further comprises capturing a tag located on or proximate to one or more of the products and reading the tag to identify the product. Identifying one or more products may further comprise capturing real-time video of the one or more products product.

In some embodiments, determining a payment account for a product is based at least in part on a financial plan of the user, wherein the financial plan of the user further comprises the most beneficial promotion to the user at that the time of the transaction. The financial plan comprises at least one of financial goals, payment goals, and personal plans.

In some embodiments, presenting an indicator on the mobile device, where the indicator is associated with the one or more products displayed on the mobile device. Presenting an indicator associated with the one or more product comprises superimposing the indicator over real-time video that is captured by the mobile device. In some embodiments, the indicator is selectable by the user.

In some embodiments, the indicator, upon being selected, provides a payment account recommendation based at least in part on types of payment accounts available to the user. In some embodiments, the indicator, upon being selected, provides a payment account recommendation based at least in part on financial institution considerations. In yet other embodiments, the indicator, upon being selected, provides a payment account recommendation based at least in part on financial plans of the user. In other embodiments, upon being selected, triggers the system to provide financing to the user for purchasing the product.

### BRIEF DESCRIPTION OF THE DRAWINGS

Having thus described embodiments of the invention in general terms, reference will now be made to the accompanying drawings, which are not necessarily drawn to scale, and wherein:

FIG. 1 provides a high level process flow illustrating a real-time appropriate payment account recommendation process, in accordance with one embodiment of the present invention;

FIG. 2 provides an appropriate payment account determination system environment, in accordance with an embodiment of the invention;

FIG. 3 provides a block diagram illustrating a mobile device, in accordance with an embodiment of the invention;

FIG. 4 provides an a representation illustrating a mobile device real-time video stream display environment, in accordance with an embodiment of the invention;

FIG. 5 provides a process map for a recommended appropriate payment, in accordance with an embodiment of the invention;

FIG. 6 provides a process map for the analysis of selecting a recommended appropriate payment account, in accordance with an embodiment of the invention;

FIG. 7 provides an account interface, in accordance with an embodiment of the invention; and

FIG. 8 provides a financial plan interface, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Although some embodiments of the invention herein are generally described as involving a “financial institution,” one of ordinary skill in the art will appreciate that other embodiments of the invention may involve other businesses that take the place of or work in conjunction with the financial institution to perform one or more of the processes or steps described herein as being performed by a financial institution. Still in other embodiments of the invention the financial institution described herein may be replaced with other types of businesses that offer payment account systems to users.

While embodiments discussed herein are generally described with respect to “real-time video streams” or “real-time video” it will be appreciated that the video stream may be captured and stored for later viewing and analysis. Indeed, in some embodiments video is recorded and stored on a mobile device and portions or the entirety of the video may be analyzed at a later time. The later analysis may be conducted on the mobile device or loaded onto a different device for analysis. The portions of the video that may be stored and analyzed may range from a single frame of video (e.g., a screenshot) to the entirety of the video. Additionally, rather than video, the user may opt to take a still picture of the environment to be analyzed immediately or at a later time. Embodiments in which real-time video, recorded video or still pictures are analyzed are contemplated herein.

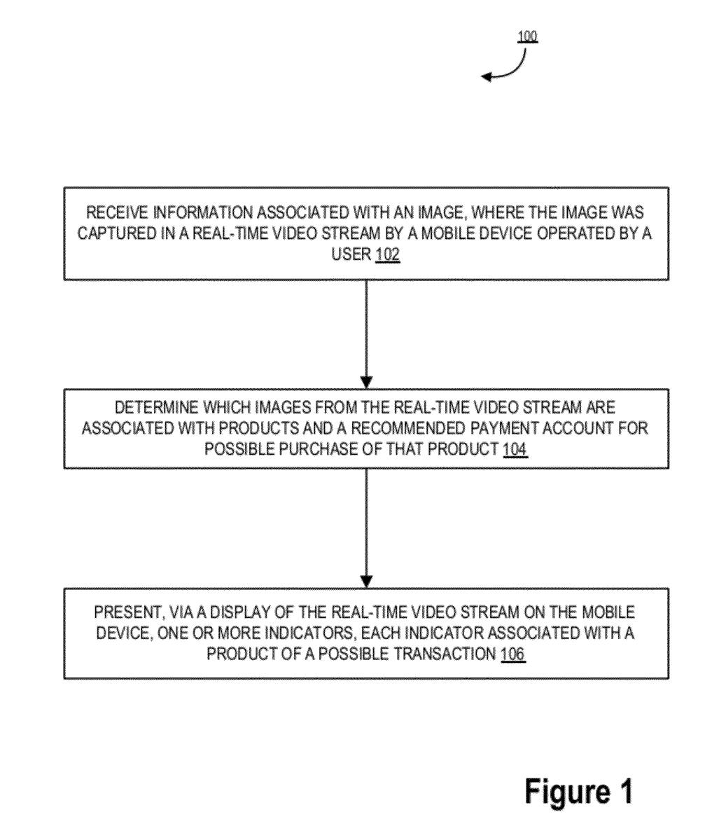

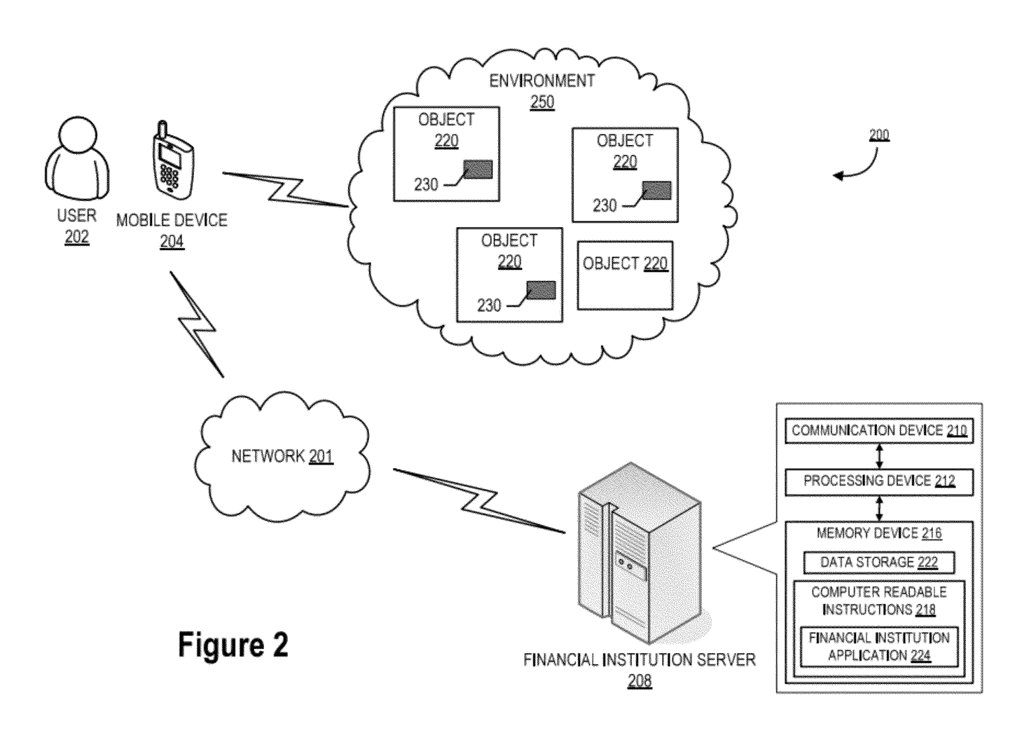

FIG. 1 illustrates a high level process flow of a real-time appropriate payment account recommendation process 100, which will be discussed in further detail throughout this specification with respect to FIGS. 2 through 8. The first step in the payment account recommendation process 100 is to receive information associated with an image, where the image was captured by a mobile device using real-time video stream, the mobile device operated by a user, as illustrated by block 102. A real-time video stream may include images of products or the like. For example, a user may move about an aisle within a retail location while capturing a real-time video stream of the environment including the products on the selves in the aisle. Next, in block 104 a determination is made as to which images from the real-time video stream are associated with products and the associated recommended payment account for the possible purchase of the product. The determination is made by analyzing the real-time video stream for objects, logos, artwork, and/or other product-indicating features or business-indications features to determine what the products are within the video stream and to then provide matches (i.e., associations) with the product to payment accounts, financial plans, and financial institution considerations of the user. In some embodiment, a payment account recommendation may be based on the payment accounts available to the user (e.g., credit cards, lines of credit, checking accounts, savings accounts, loans, etc.). In some embodiment, a payment account recommendation may by based on the financial plans of the user (e.g., financial goals, payment strategies, personal planning, etc.). In some embodiment, a payment account recommendation may be based on financial institution considerations (e.g., user transaction history, account status updates, budget impact, true cost of credit, etc.). In some embodiments, a combination of payment accounts available to the user, financial plans of the user, and/or financial institution considerations may be used to determine a payment account recommendation. Thereafter, at block 106 one or more indicators are presented on the display of the mobile device in conjunction with the real-time video stream. The indicator may take various forms, such as display of a tag, a highlighted area, a hot-spot, or the like. In specific embodiments, the indicator is a selectable indicator, such that a user may select (e.g., click-on, hover-over, touch the display, provide a voice command, and/or the like) the product or indicator to provide display of specific information related to the product, including but not limited to the recommended payment account, special offers, financing, budget impact data, and/or true cost of credit if the product is purchased. In some embodiments, the indicator itself may provide the information or a portion of the information to the user.

FIG. 2 illustrates an appropriate payment account determination system environment 200, in accordance with one embodiment of the present invention and is only one example of an embodiment of an appropriate payment account determination system environment 200, and it will be appreciated that in other embodiments one or more of the systems, devices, or servers may be combined into a single system, device, or server, or be made up of multiple systems, devices, or servers. As illustrated in FIG. 2, the financial institution server 208 is operatively coupled, via a network 201 to the mobile device 204. In this way, the financial institution server 208 can send information to and receive information from the mobile device 204, to associate indicators within the real-time video stream to a recommended appropriate payment account.

The network 201 may be a global area network (GAN), such as the Internet, a wide area network (WAN), a local area network (LAN), or any other type of network or combination of networks. The network 201 may provide for wireline, wireless, or a combination wireline and wireless communication between devices on the network.

In some embodiments, the user 202 is an individual. The user 202 may be at a retail store, near a service center, and/or within real-time video range of any product and/or service the user 202 may wish to purchase. The purchase may be made by the user 202 using the mobile device 204, such as a mobile wallet (i.e. smart phone, PDA, etc.) or other types of payment options, such as credit cards, checks, cash, debit cards, loans, lines of credit, virtual currency, etc. that allow the user 202 to purchase a product and/or service.

As illustrated in FIG. 2, the financial institution server 208 generally comprises a communication device 210, a processing device 212, and a memory device 216. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 212 is operatively coupled to the communication device 210 and the memory device 216. The processing device 212 uses the communication device 210 to communicate with the network 201 and other devices on the network 201, such as, but not limited to the mobile device 204. As such, the communication device 210 generally comprises a modem, server, or other device for communicating with other devices on the network 201.

In some embodiments, the processing device 212 may also be capable of operating one or more applications, such as one or more applications functioning as an artificial intelligence (“AI”) engine. The processing device 212 may recognize objects that it has identified in prior uses by way of the AI engine. In this way, the processing device 212 may recognize specific objects and/or classes of objects, and store information related to the recognized objects in one or more memories and/or databases discussed herein. Once the AI engine has thereby “learned” of an object and/or class of objects, the AI engine may run concurrently with and/or collaborate with other modules or applications described herein to perform the various steps of the methods discussed. For example, in some embodiments, the AI engine recognizes an object that has been recognized before and stored by the AI engine. The AI engine may then communicate to another application or module of the mobile device and/or server, an indication that the object may be the same object previously recognized. In this regard, the AI engine may provide a baseline or starting point from which to determine the nature of the object. In other embodiments, the AI engine's recognition of an object is accepted as the final recognition of the object.

As further illustrated in FIG. 2, the financial institution server 208 comprises computer-readable instructions 218 stored in the memory device 216, which in one embodiment includes the computer-readable instructions 218 of a financial institution application 224. In some embodiments, the memory device 216 includes data storage 222 for storing data related to the appropriate payment accounts including but not limited to data created and/or used by the financial institution application 224 or the accounts, financial plans, or financial institution considerations for the user 202.

In the embodiment illustrated in FIG. 2 and described throughout much of this specification, the financial institution application 224 allows the user 202 to manually input, via a mobile device 204 or another device, preferred appropriate payment account criteria. The preferred appropriate payment account criteria may be pre-programmed by the user 202 as AR preferences, so that the mobile device 204 may provide recommended payment account data to the user for each individual object 220 the user 202 may wish to purchase. In one example, the processing device 310 of the mobile device 204 allows the user 202 to indicate accounts available and financial plans to the financial institution application 224. The data stored within the financial institution application 224 provides computer readable instructions 218 to the processing device 212 to allow for selection of the recommended appropriate payment account for an object 220. The financial institution application 224 stores the preferred appropriate payment account system criteria including, but not limited to accounts available and financial plans that may be established by the user 202. As used herein, accounts available and/or financial plans may be established by manual input by the user 202 via the mobile device 204 or established by the financial institution server 208 automatically.

In one embodiment, as explained in further detail below, the accounts available within the financial institution application 224 include all financial accounts available to the user 202. In some embodiments, the accounts available to the user 202 may include payment accounts that the user 202 has with a primary financial institution, secondary financial institution, or other entity that the user 202 may use to make a transaction. For example, payment accounts may include cash, check, credit cards, debit cards, retailer cards, and/or lines of credit. In some embodiments, an identification of the accounts available to the user 202 may be stored in the memory device 216 of the financial institution server 208, because the user 202 may have a prior relationship and/or accounts with the financial institution. In other embodiments, the accounts available to the user 202 may be determined by accessing other financial institution computer systems.

In one embodiment, as explained in further detail below, the financial plans stored within the financial institution application 224 includes financial goals and payment strategies of the user 202. The financial goals of the user 202 may include savings goals. These savings goals may include saving for a child's college, an investment, saving to reach a specific amount, etc. Further, the financial goals of the user 202 may include retirement savings goals. For example, the payment strategies of the user 202 may include loan repayment (e.g. student loan repayment, car loan repayment, etc.), paying off credit card debt (e.g., paying off one credit card with higher interest rates faster than other debt), and may also include mortgage repayment. In some embodiments, the financial plan may be created by accessing the financial information of the user 202 stored in the memory device 216. In other embodiments, the financial plan may be created by user 202 input via the mobile device 204 using the user input devices 340 or some other means of communication.

In one embodiment, as explained in further detail below, financial plans stored within the financial institution application 224 may further include user 202 vacation planning, job loss planning, emergency planning, and tax planning. For example, vacation planning may include a user 202 saving for airfare or other travel expenses. Job loss planning allows the user to direct the system to allocate financial transaction requests to accounts to maximize available money in case of unemployment of the user 202. Emergency planning allows the user to direct the system to allocate transaction requests to accounts to maximize finances in case of an emergency situation, such as a family illness. Tax planning allows the user 202 to direct the system to allocate transaction requests to accounts to maximize tax planning strategies set by the user 202. In some embodiments, the consumer plan may be created by accessing financial information of the user 202 stored in the financial institution account system 211. In some embodiments, the user plan may be created by user 202 input via the mobile device 204 using user input devices 340 or some other means of communication.

In some embodiments, financial institution considerations may be created by accessing financial information of the user 202 stored in the financial institution server 208. In the embodiment illustrated in FIG. 2 and described throughout this specification, the financial institution server 208 may receive the financial information of the user 202. In one example, the financial institution application 224 accesses the transaction history of the user 202 and/or the account status of the payment account that the user 202 would like to use for various transactions. User transaction history may include previous transaction requests from the same merchant or other merchants, in order to determine the payment account the user historically uses in various types of transactions. For example, a user 202 always uses a specific credit card for all purchases at a grocery store, the financial institution server 208 may recognize the historically used credit card and apply the purchase from the grocery store to that card. The financial institution application 224 may also access the user accounts to ensure that the funds in a payment account are available prior to the user 202 applying a transaction to the recommended payment account. In some embodiments, the account status of the payment accounts may ensure that the credit limit for an account has not yet been reached.

In some embodiments, as described in further detail below, the financial institution application 224 may recognize an Marker 230 and/or objects 220 within an environment 250. The Marker 230 may be interpreted with respect to data in the memory device 216 and be recognized as possible products and/or services that may be available to the user 202. In this way, the financial institution server 208 provides Marker 230 interpretation and analysis with respect to the data on the financial institution server 208.

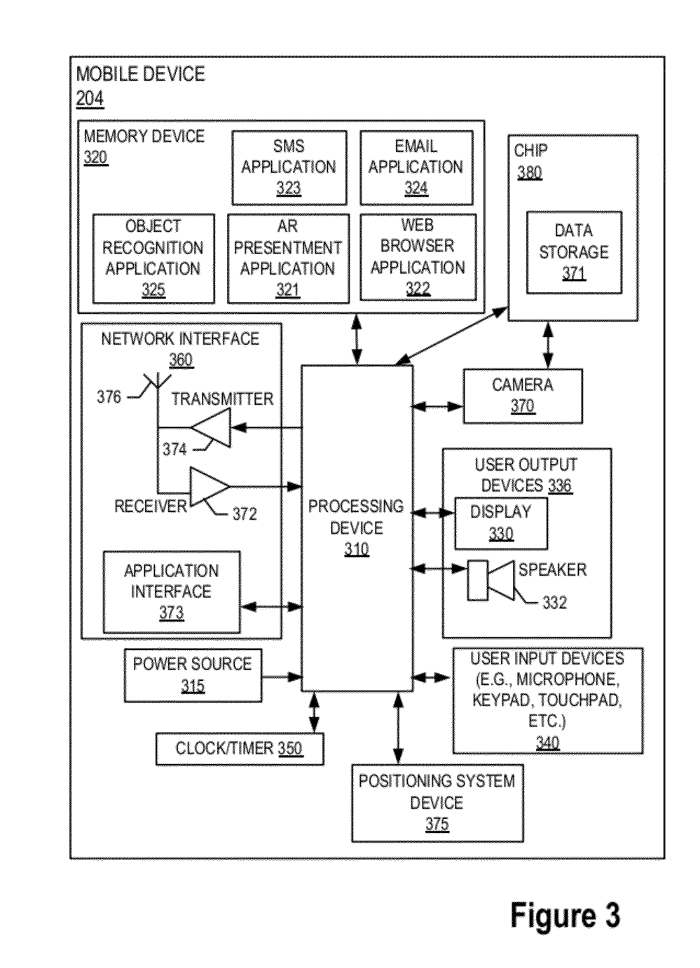

As further illustrated is FIG. 2 is an environment 250. The user 202 may utilizes a mobile device 204 to capture real-time video of an environment 250 in an augmented reality experience. As described in further detail below with respect to FIG. 3, the mobile device 204 may be any mobile communication device. The mobile device 204 has the capability of capturing real-time video of the surrounding environment 250. The real-time video capture may be by any means known in the art, such as for example, a mobile telephone equipped with a camera capable of video capture.

The environment 250 contains a number of objects 220. Objects 220 include, but are not limited to products and/or services for which the user 202 may wish to view a recommended appropriate payment account. For example, an object 220 may be a product, such as a television, vehicle, computer, etc. or an object 220 may be a service, such as a dry cleaner, pest control specialist, automotive repair shop, etc. Some of such objects 220 may include a marker 230 identifiable by the mobile device 204 or application accessible through the mobile device. A marker 230 may be any type of marker that is a distinguishing feature that can be interpreted to identify specific objects 220. In some embodiments, the marker 230 may be interpreted by the mobile device 204. In other embodiments, the marker 230 may be interpreted by the financial institution server 208. In yet other embodiments the marker 230 may be interpreted by both the mobile device 204 and the financial institution server 208. For instance, a marker 230 may be alpha-numeric characters, symbol, logo, shape, ratio of size of one feature to another feature, a product identifying code such as a bar code, electromagnetic radiation such as radio waves (e.g., radio frequency identification (RFID)), architectural features, color, etc. In some embodiments, the marker 230 may be audio and the mobile device 204 may be capable of utilizing audio recognition to identify words or unique sounds broadcast by the products, service, location, merchant, etc. The marker 230 may be any size, shape, etc. Indeed, in some embodiments, the marker 230 may be very small relative to the object 220 such as the alpha-numeric characters that identify the name or model of an object 220, whereas, in other embodiments, the marker 230 is the entire object 220 such as the unique shape, size, structure, etc.

In some embodiments, the marker 230 is not actually a physical marker located on or being broadcast by the object 220. For instance, the marker 230 may be some type of identifiable feature that is an indication that the object 220 is nearby. In some embodiments, the marker 230 for an object 220 may actually be the marker 230 for a different object 220. For example, the mobile device 204 may recognize a particular building as being “Building A.” Data stored in the data storage 371 may indicate that “Building B” is located directly to the east and next to “Building A.” Thus, marker 230 for an object 220 that are not located on or being broadcast by the object 220 are generally based on fixed facts about the object 220 (e.g., “Building B” is next to “Building A”). However, it is not a requirement that such a marker 230 be such a fixed fact. The marker 230 may be anything that enables the mobile device 204 and/or the financial institution application 224 to interpret to a desired confidence level what the object is. For example, the mobile device 204, object recognition application 325 and/or AR presentation application 321 may be used to identify a particular person as a first character from a popular show, and thereafter utilize the information that the first character is nearby features of other characters to interpret that a second character, a third character, etc. are nearby, whereas without the identification of the first character, the features of the second and third characters may not have been used to identify the second and third characters. This example may also be applied to objects outside of people.

The marker 230 may also be, or include, social network data, such as data retrieved or communicated from the Internet, such as tweets, blog posts, social networking site posts, various types of messages and/or the like. In other embodiments, the marker 230 is provided in addition to social network data as mentioned above. For example, mobile device 204 may capture a video stream and/or one or more still shots of a large gathering of people. In this example, as above, one or more people dressed as characters in costumes may be present at a specified location. The mobile device 204, object recognition application 325, and/or the AR presentation application 321 may identify several social network indicators, such as posts, blogs, tweets, messages, and/or the like indicating the presence of one or more of the characters at the specified location. In this way, the mobile device 204 and associated applications may communicate information regarding the social media communications to the user and/or use the information regarding the social media communications in conjunction with other methods of object recognition. For example, the mobile device 204 object recognition application 325, and/or the AR presentation application 321 performing recognition of the characters at the specified location may confirm that the characters being identified are in fact the correct characters based on the retrieved social media communications. This example may also be applied objects outside of people.

In some embodiments, the mobile device and/or server accesses one or more other servers, social media networks, applications and/or the like in order to retrieve and/or search for information useful in performing an object recognition. In some embodiments, the mobile device and/or server accesses another application by way of an application programming interface or API. In this regard, the mobile device and/or server may quickly search and/or retrieve information from the other program without requiring additional authentication steps or other gateway steps.

While FIG. 2 illustrates that the objects 220 with markers 230 only include a single marker 230, it will be appreciated that the object 220 may have any number of markers 230 with each equally capable of identifying the object 220. Similarly, multiple markers 230 may be identified by the mobile device 204 such that the combination of the markers 230 may be utilized to identify the object 220. For example, the facial recognition may identify a person as a famous athlete, and thereafter utilize the uniform the person is wearing to confirm that it is in fact the famous athlete.

In some embodiments, a marker 230 may be the location of the object 220. In such embodiments, the mobile device 204 may utilize GPS software to determine the location of the user 202. As noted above, a location-based marker 230 could be utilized in conjunction with other non-location-based markers 230 identifiable and recognized by the mobile device 204 to identify the object 220. However, in some embodiments, a location-based marker 230 may be the only marker 230. For instance, in such embodiments, the mobile device 204 may utilize GPS software to determine the location of the user 202 and a compass device or software to determine what direction the mobile device 204 is facing in order to identify the object 220. In still further embodiments, the mobile device 204 does not utilize any GPS data in the identification. In such embodiments, markers 230 utilized to identify the object 220 are not location-based.

FIG. 3 illustrates an embodiment of a mobile device 204 that may be configured to execute augmented reality functionality. A “mobile device” 204 may be any mobile communication device, such as a cellular telecommunications device (i.e., a cell phone or mobile phone), personal digital assistant (PDA), a mobile Internet accessing device, or other mobile device including, but not limited to portable digital assistants (PDAs), pagers, mobile televisions, gaming devices, laptop computers, cameras, video recorders, audio/video player, radio, GPS devices, any combination of the aforementioned, or the like.

The mobile device 204 may generally include a processing device 310 communicably coupled to such devices as a memory device 320, user output devices 336, user input devices 340, a network interface 360, a power source 315, a clock or other timer 350, a camera 370, a positioning system device 375, one or more Chips 380, etc.

In some embodiments, the mobile device and/or the server access one or more databases or datastores (not shown) to search for and/or retrieve information related to the object and/or marker. In some embodiments, the mobile device and/or the server access one or more datastores local to the mobile device and/or server and in other embodiments, the mobile device and/or server access datastores remote to the mobile device and/or server. In some embodiments, the mobile device and/or server access both a memory and/or datastore local to the mobile device and/or server as well as a datastore remote from the mobile device and/or server

The processing device 310 may include functionality to operate one or more software programs or applications, which may be stored in the memory device 320. For example, the processing device 310 may be capable of operating a connectivity program, such as a web browser application 322. The web browser application 322 may then allow the mobile device 204 to transmit and receive web content, such as, for example, location-based content and/or other web page content, according to a Wireless Application Protocol (WAP), Hypertext Transfer Protocol (HTTP), and/or the like.

The processing device 310 may also be capable of operating applications, such as an object recognition application 325 and/or an AR presentment application 321. The object recognition application 325 and/or AR presentment application 321 may be downloaded from a server and stored in the memory device 320 of the mobile device 204. Alternatively, the object recognition application 325 and/or AR presentment application 321 may be pre-installed and stored in a memory in the chip 380. In such an embodiment, the user may not need to download the object recognition application 325 and/or the AR presentment application 321 from a server. In this way, the object recognition application 325 and/or the AR presentment application 321 may remain at the server, such as the financial institution server 208, within the financial institution application 224.

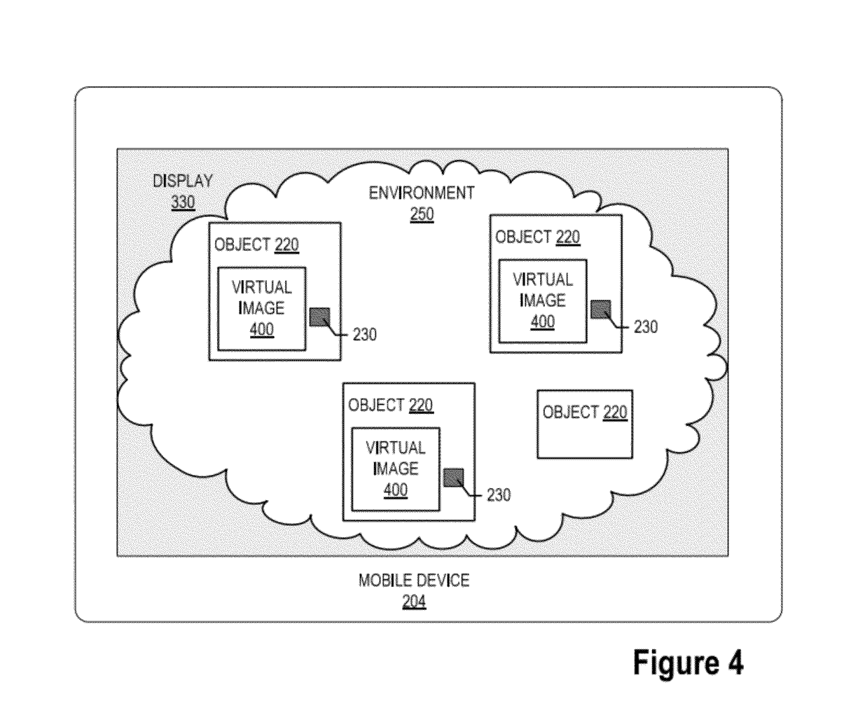

The object recognition application 325 provides the mobile device 204 with object recognition capabilities. In this way, objects 220 such as products and/or the like may be recognized by the object 220 itself and/or markers 230 associated with the objects 220. This is described in further detail below with respect to FIG. 4. In this way the object recognition application 325 may communicate with other devices on the network 201 to determine the object 220 within the real-time video stream.

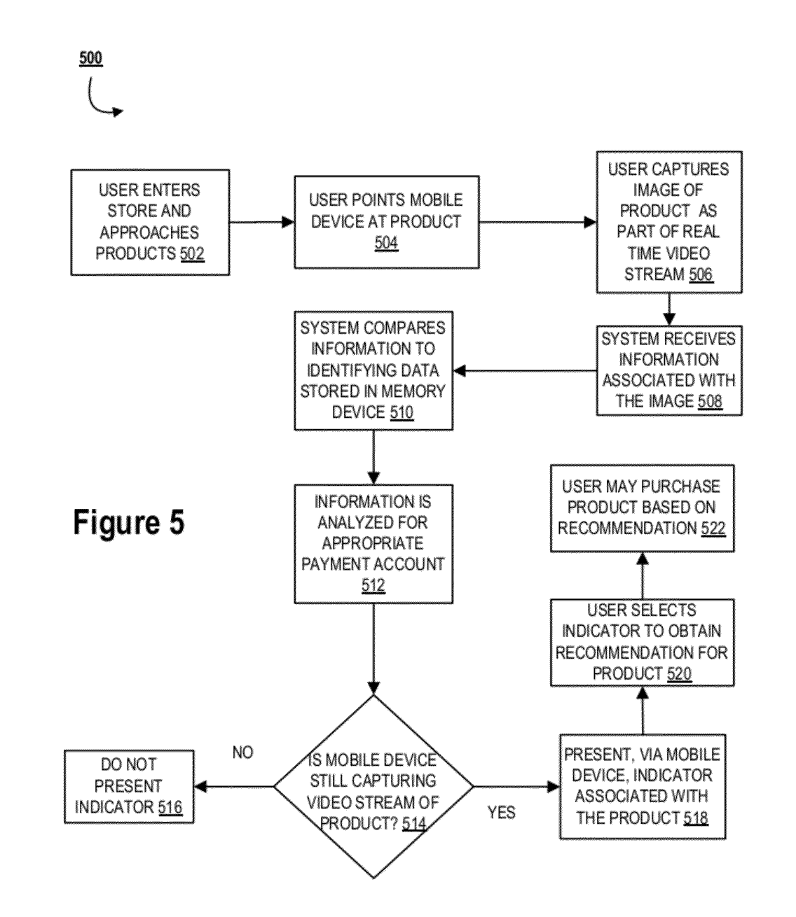

The AR presentment application 321 provides the mobile device 204 with AR capabilities. In this way, the AR presentment application 321 may provide superimposed indicators related to the object 220 in the real-time video stream, such that the user 202 may have access to the targeted offers by selecting an indicator superimposed on the real-time video stream. The AR presentment application 321 may communicate with the other devices on the network 201 to provide the user 202 with indications associated with targeted offers for objects 202 in the real-time video display. The presentation and selection of indicators provided to the user 202 via the AR presentment application 321 is described in further detail below with respect to FIG. 5.

In some embodiments, the processor 310 may also be capable of operating one or more applications, such as one or more applications functioning as an artificial intelligence (“AI”) engine. The processor 310 may recognize objects that it has identified in prior uses by way of the AI engine. In this way, the processor 310 may recognize specific objects and/or classes of objects, and store information related to the recognized objects in one or more memories and/or databases discussed herein. Once the AI engine has thereby “learned” of an object and/or class of objects, the AI engine may run concurrently with and/or collaborate with other modules or applications described herein to perform the various steps of the methods discussed. For example, in some embodiments, the AI engine recognizes an object that has been recognized before and stored by the AI engine. The AI engine may then communicate to another application or module of the mobile device and/or server, an indication that the object may be the same object previously recognized. In this regard, the AI engine may provide a baseline or starting point from which to determine the nature of the object. In other embodiments, the AI engine's recognition of an object is accepted as the final recognition of the object.

The chip 380 may include the necessary circuitry to provide both object recognition and AR functionality to the mobile device 204. Generally, the chip 380 will include data storage 371 which may include data associated with the objects within a real-time video stream that the object recognition application 325 identifies as having a certain marker(s) 230. The chip 380 and/or data storage 371 may be an integrated circuit, a microprocessor, a system-on-a-chip, a microcontroller, or the like. As discussed above, in one embodiment, the chip 380 may provide both object recognition and/or the AR functionality to the mobile device 204.

Of note, while FIG. 3 illustrates the chip 380 as a separate and distinct element within the mobile device 204, it will be apparent to those skilled in the art that the chip 380 functionality may be incorporated within other elements in the mobile device 204. For instance, the functionality of the chip 380 may be incorporated within the memory device 320 and/or the processing device 310. In a particular embodiment, the functionality of the chip 380 is incorporated in an element within the mobile device 204 that provides the object recognition and AR capabilities to the mobile device 204. Still further, the chip 380 functionality may be included in a removable storage device such as an SD card or the like.

The processing device 310 may be configured to use the network interface 360 to communicate with one or more other devices on a network 201 such as, but not limited to the financial institution server 208. In this regard, the network interface 360 may include an antenna 376 operatively coupled to a transmitter 374 and a receiver 372 (together a “transceiver”). The processing device 310 may be configured to provide signals to and receive signals from the transmitter 374 and receiver 372, respectively. The signals may include signaling information in accordance with the air interface standard of the applicable cellular system of the wireless telephone network that may be part of the network 201. In this regard, the mobile device 204 may be configured to operate with one or more air interface standards, communication protocols, modulation types, and access types. By way of illustration, the mobile device 204 may be configured to operate in accordance with any of a number of first, second, third, and/or fourth-generation communication protocols and/or the like. For example, the mobile device 204 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 204 may also be configured to operate in accordance with non-cellular communication mechanisms, such as via a wireless local area network (WLAN) or other communication/data networks.

The network interface 360 may also include an application interface 373 in order to allow a user 202 to execute some or all of the above-described processes with respect to the object recognition application 325, the AR presentment application 321 and/or the chip 380. The application interface 373 may have access to the hardware, e.g., the transceiver, and software previously described with respect to the network interface 360. Furthermore, the application interface 373 may have the ability to connect to and communicate with an external data storage on a separate system within the network 201. In some embodiments, the external AR data is stored in the memory device 216 of the financial institution server 208.

As described above, the mobile device 204 may have a user interface that includes user output devices 336 and/or user input devices 340. The user output devices 336 may include a display 330 (e.g., a liquid crystal display (LCD) or the like) and a speaker 332 or other audio device, which are operatively coupled to the processing device 310. The user input devices 340, which may allow the mobile device 204 to receive data from a user 202, may include any of a number of devices allowing the mobile device 204 to receive data from a user 202, such as a keypad, keyboard, touch-screen, touchpad, microphone, mouse, joystick, other pointer device, button, soft key, and/or other input device(s).

The mobile device 204 may further include a power source 315. Generally, the power source 315 is a device that supplies electrical energy to an electrical load. In some embodiment, power source 315 may convert a form of energy such as solar energy, chemical energy, mechanical energy, etc. to electrical energy. Generally, the power source 315 in a mobile device 204 may be a battery, such as a lithium battery, a nickel-metal hydride battery, or the like, that is used for powering various circuits, e.g., the transceiver circuit, and other devices that are used to operate the mobile device 204. Alternatively, the power source 315 may be a power adapter that can connect a power supply from a power outlet to the mobile device 204. In such embodiments, a power adapter may be classified as a power source “in” the mobile device.

The mobile device 204 may also include a memory device 320 operatively coupled to the processing device 310. As used herein, memory may include any computer readable medium configured to store data, code, or other information. The memory device 320 may include volatile memory, such as volatile Random Access Memory (RAM) including a cache area for the temporary storage of data. The memory device 320 may also include non-volatile memory, which can be embedded and/or may be removable. The non-volatile memory may additionally or alternatively include an electrically erasable programmable read-only memory (EEPROM), flash memory or the like.

The memory device 320 may store any of a number of applications or programs which comprise computer-executable instructions/code executed by the processing device 310 to implement the functions of the mobile device 204 described herein. For example, the memory device 320 may include such applications as an object recognition application 325, an AR presentment application 321, a web browser application 322, an SMS application 323, an email application 324, etc.

FIG. 4 further illustrates a mobile device 204 wherein the user 202 has executed an object recognition application 325, an AR presentment application 321, and a real-time video capture device (e.g., camera 370) is utilized to display the surrounding environment 250 on the display 330 of the mobile device 204. In some embodiments, the mobile device 204 is configured to utilize markers 230 to identify objects 220, such as products and/or services, and indicate to the user 202 identified objects 220 by displaying a virtual image 400 on the mobile device display 330. As illustrated in FIG. 4, if an object 220 does not have any markers 230 (or at least enough Markers 230 to yield object identification), the object 220 will be displayed without an associated virtual image 400.

The object recognition application 325 of the mobile device 204 may use any type of means in order to identify desired objects 220. For instance, the object recognition application 325 may utilize one or more pattern recognition algorithms to analyze objects in the environment 250 and compare with markers 230 in data storage 371 which may be contained within the mobile device 204 (such as within chip 380) or externally on a separate system accessible via the connected network 201, such as but not limited to the financial institution server 208. For example, the pattern recognition algorithms may include decision trees, logistic regression, Bayes classifiers, support vector machines, kernel estimation, perceptrons, clustering algorithms, regression algorithms, categorical sequence labeling algorithms, real-valued sequence labeling algorithms, parsing algorithms, general algorithms for predicting arbitrarily-structured labels such as Bayesian networks and Markov random fields, ensemble learning algorithms such as bootstrap aggregating, boosting, ensemble averaging, combinations thereof, and the like.

Upon identifying an object 220 within the real-time video stream via the object recognition application 325, the mobile device 204 is configured to superimpose a virtual image 400 on the mobile device display 330 utilizing the AR presentment application 321. The virtual image 400 is generally a tab or link displayed such that the user 202 may “select” the virtual image 400 and retrieve information related to the identified object. The information may include any desired information associated with the selected object and may range from basic information to greatly detailed information. In some embodiments, the virtual image 400 may provide the user 202 with an internet hyperlink to further information on the object 220. The information may include, for example, all types of media, such as text, images, clipart, video clips, movies, or any other type of information desired. In yet other embodiments, the virtual image 300 information related to the identified object may be visualized by the user 210 without “selecting” the virtual image 300.

In embodiments in which the virtual image 400 provides an interactive tab to the user 202 utilizing the AR presentment application 321 of the mobile device 204, the user 202 may select the virtual image 400 by any conventional means for interaction with the mobile device 204. For instance, in some embodiments, the user 202 may utilize an input device 340 such as a keyboard to highlight and select the virtual image 400 in order to retrieve the information. In a particular embodiment, the mobile device display 330 includes a touch screen that the user may employ to select the virtual image 400 utilizing the user's finger, a stylus, or the like.

In some embodiments, the virtual image 400 is not interactive and simply provides information to the user 202 by superimposing the virtual image 400 onto the display 330. For example, in some instances it may be beneficial for the object recognition application 325 and/or the AR presentment application 321 to merely identify an object 220, just identify the object's name/title, give brief information about the object, etc., rather than provide extensive detail that requires interaction with the virtual image 400. The mobile device 204 along with the object recognition application 325 and/or the AR presentment application 321 are capable of being tailored to a user's desired preferences.

Furthermore, the virtual image 400 may be displayed at any size on the mobile device display 330. The virtual image 400 may be small enough that it is positioned on or next to the object 220 being identified such that the object 220 remains discernable behind the virtual image 400. Additionally, the virtual image 400 may be semi-transparent such that the object 220 remains discernable behind the virtual image. In other embodiments, the virtual image 400 may be large enough to completely cover the object 220 portrayed on the display 330. Indeed, in some embodiments, the virtual image 400 may cover a majority or the entirety of the mobile device display 330.

The user 202 may opt to execute the object recognition application 325 and/or the AR presentment application 321 at any desired moment and begin video capture and analysis. However, in some embodiments, the object recognition application 325 and/or the AR presentment application 321 includes an “always on” feature in which the mobile device 204 is continuously capturing video and analyzing the objects 220 within the video stream. In such embodiments, the object recognition application 325 may be configured to alert the user 202 that a particular object 220 has been identified. The user 202 may set any number of user preferences to tailor the AR experience to his needs. For instance, the user 202 may opt to only be alerted if a certain particular object 220 is identified. Additionally, it will be appreciated that the “always on” feature in which video is continuously captured may consume the mobile device power source 315 more quickly. Thus, in some embodiments, the “always on” feature may disengage if a determined event occurs such as low power source 315, low levels of light for an extended period of time (e.g., such as if the mobile device 204 is in a user's pocket obstructing a clear view of the environment 250 from the mobile device 204), if the mobile device 204 remains stationary (thus receiving the same video stream) for an extended period of time, the user sets a certain time of day to disengage, etc. Conversely, if the “always on” feature is disengaged due to the occurrence of such an event, the user 202 may opt for the “always on” feature to re-engage after the duration of the disengaging event (e.g., power source 315 is re-charged, light levels are increased, etc.).

In some embodiments, the user 202 may identify objects 220 that the object recognition application 325 does not identify and add it to the data storage 371 with desired information in order to be identified and/or displayed in the future. For instance, the user 202 may select an unidentified object 220 and enter a name/title and/or any other desired information for the unidentified object 220. In such embodiments, the object recognition application 325 may detect/record certain markers 230 about the object so that the pattern recognition algorithm(s) (or other identification means) may detect the object 220 in the future. Furthermore, in cases where the object information is within the data storage 371, but the object recognition application 325 fails to identify the object 220 (e.g., one or more identifying characteristics or markers 230 of the object has changed since it was added to the data storage 371 or the marker 230 simply was not identified), the user 202 may select the object 220 and associate it with an object 220 already stored in the data storage 371. In such cases, the object recognition application 325 may be capable of updating the markers 230 for the object 220 in order to identify the object in future real-time video streams.

In addition, in some embodiments, the user 202 may opt to edit the information or add to the information provided by the virtual object 400. For instance, the user 202 may opt to include user-specific information about a certain object 220 such that the information may be displayed upon a future identification of the object 220. Conversely, in some embodiments, the user may opt to delete or hide an object 220 from being identified and a virtual object 400 associated therewith being displayed on the mobile device display 330.

Furthermore, in some instances, an object 220 may include one or more markers 230 identified by the object recognition application 325 that leads the object recognition application 325 to associate an object with more than one object in the data storage 371. In such instances, the user 202 may be presented with the multiple candidate identifications and may opt to choose the appropriate identification or input a different identification. The multiple candidates may be presented to the user 202 by any means. For instance, in one embodiment, the candidates are presented to the user 202 as a list wherein the “strongest” candidate is listed first based on reliability of the identification. Upon input by the user 202 identifying the object 220, the object recognition application 325 may “learn” from the input and store additional markers 230 in order to avoid multiple identification candidates for the same object 220 in future identifications.

Additionally, the object recognition application 325 may utilize other metrics for identification than identification algorithms. For instance, the object recognition application 325 may utilize the user's location, time of day, season, weather, speed of location changes (e.g., walking versus traveling), “busyness” (e.g., how many objects are in motion versus stationary in the video stream), as well any number of other conceivable factors in determining the identification of objects 220. Moreover, the user 202 may input preferences or other metrics for which the object recognition application 325 may utilize to narrow results of identified objects 220.

The AR presentment application 321 may then provide virtual objects or indicators associated with the objects in the real-time video stream. The AR presentment application 321, in this way, may provide for superimposing a virtual object and/or indicators associated with objects 230 in the video stream, such that the user 202 may receive more information associated with the object 220 in the real-time video stream.

In some embodiments, the AR presentment application 321 may have the ability to gather and report user interactions with displayed virtual objects 400. The data elements gathered and reported may include, but are not limited to, number of offer impressions; time spent “viewing” an offer, product, object or business; number of offers investigated via a selection; number of offers loaded to an electronic wallet and the like. Such user interactions may be reported to any type of entity desired. In one particular embodiment, the user interactions may be reported to a financial institution and the information reported may include user financial behavior, purchase power/transaction history, and the like.

In some embodiments, the information provided by the real-time video stream may be compared to data provided to the system through an API. In this way, the data may be stored in a separate API and be implemented by request from the mobile device and/or server accesses another application by way of an API.

In various embodiments, information associated with or related to one or more objects that is retrieved for presentation to a user via the mobile device may be permanently or semi-permanently associated with the object. In other words, the object may be “tagged” with the information. In some embodiments, a location pointer is associated with an object after information is retrieved regarding the object. In this regard, subsequent mobile devices capturing the object for recognition may retrieve the associated information, tags and/or pointers in order to more quickly retrieve information regarding the object. In some embodiments, the mobile device provides the user an opportunity to post messages, links to information or the like and associate such postings with the object. Subsequent users may then be presenting such postings when their mobile devices capture and recognize an object. In some embodiments, the information gathered through the recognition and information retrieval process may be posted by the user in association with the object. Such tags and/or postings may be stored in a predetermined memory and/or database for ease of searching and retrieval.

FIG. 5 illustrates a process map for a recommended appropriate payment account using a real-time video stream 500. At block 502 the user 202 enters a store and approaches products. A store may be, but is not limited to, a restaurant, retail store, vendor, warehouse, service provider, Internet store, or any other location that may tender products in return for payment. Once the user 202 enters the store the user 202 may point is mobile device at a product or the environment, at block 504. At block 506 the user 202 may capture images, while pointing his mobile device, of products as part of a real-time video stream. Once the user has captured images, the system may receive the information associated with the image 508. The image may be a single frame of video (e.g., a screenshot) to the entirety of the video. Additionally, rather than video, the user may opt to take a still picture of the environment to be the image received. The image may further comprise multiple single images compiled together. In some embodiments, the system may be provided by the financial institution, such as described above with respect to the financial institution server 208. In some embodiments, the system may be provided by the user 202, such as described above with respect to the mobile device 204. Once the system receives the information associated with the image the system compares the information from the image to identifying data stored in the memory device, as illustrated in block 510. In some embodiments the information associated with the image may be utilized by the object recognition application 325 to determine the object 230 in the image. The identifying data may determine the product and/or service in the image, from the information sent to the system. For example, if the user 202 is a car dealership, the data from the image the user 202 took may provide data to the system such that the system may know the exact make, model, price, and history of all of the vehicles in the image. At block 512 the information is analyzed to provide the recommended appropriate payment account. The recommended appropriate payment account depends on several criteria, including but not limited to the type of transaction possible to the user 202, the types of payment accounts available to the user 202, the user's financial plan, and/or financial institution considerations. In some embodiments, the system may determine the criteria independent of the user 202. In some embodiments, the user 202 may pre-provide inputs at to the criteria.

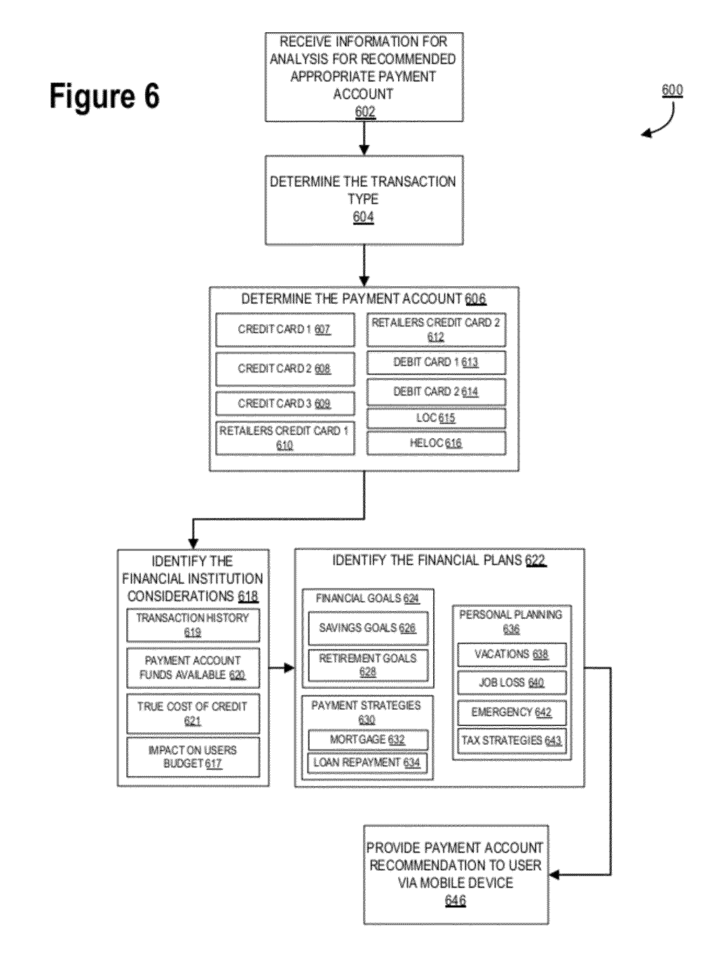

FIG. 6 illustrates the analysis for selecting the recommended payment account for a possible purchase of a product with respect to the selection criteria described above 600. As illustrated by block 602, the process 600 begins by the system receiving information for analysis for a recommended appropriate payment account. Then, as illustrated by block 604, the system may determine the transaction type. In some embodiments, the transaction type may be a purchase by an individual at a merchant. A user 202 may wish to make a purchase at a merchant, online or offline, over the phone, at point-of-sale (“POS”) systems, etc. For example, a user 202 may wish to purchase groceries at a grocery store and clothing at a retail store and pay for both of these purchases using the same account, such as a credit card or other accounts that are available to the user 202. Determining the type of transaction may allow the financial institution to recommend which account to apply the transaction. For example, if the transaction is made for fuel at a gas station, the appropriate payment account may be the credit card that provides the largest percent cash back for that particular gas station. In some embodiments, the type of transaction may be determined based on the type of product (e.g., fuel or clothing) purchased by the user 202.

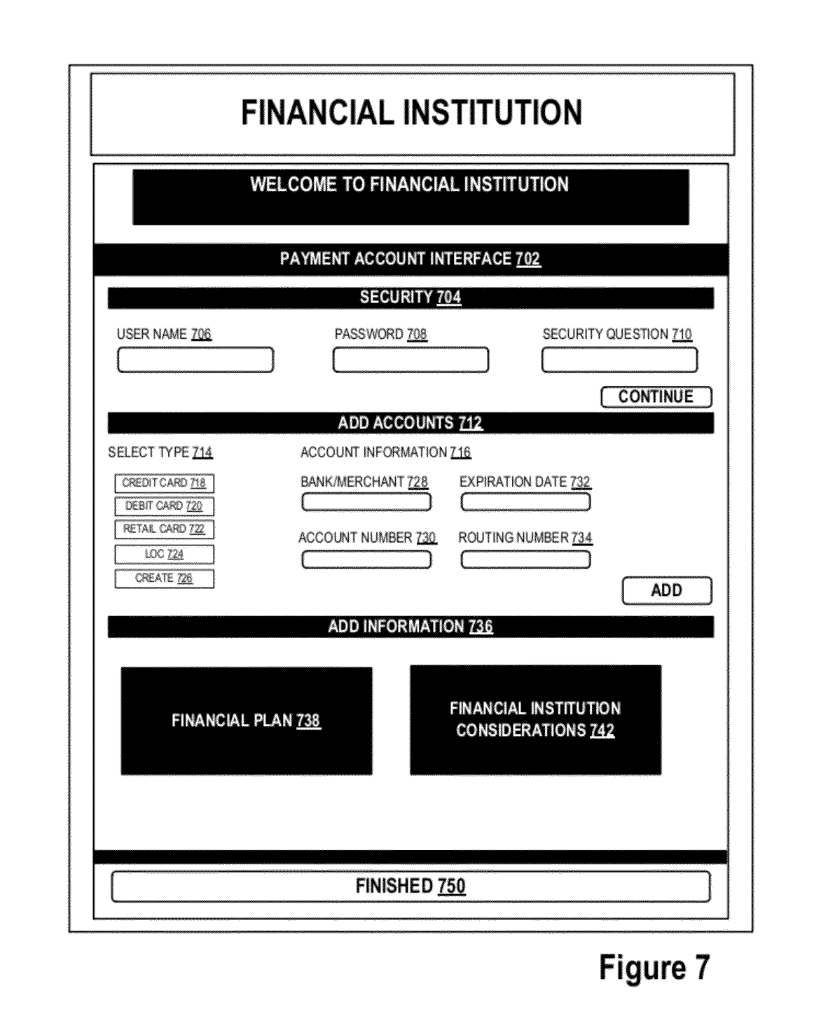

As illustrated by block 606 in FIG. 6, the next step in the analysis 600 is determining the payment accounts available to the user 202, in which the system may select a recommended payment account. The accounts from which the system comprise the account selection pool. In some embodiments, all payment accounts available to the user 202 may be in the selection pool. In some embodiments, all payment accounts available to the user 202 may not be in the account selection pool. The account selection pool may be populated in several ways. In one embodiment, the accounts in the account selection pool may be provided by the user 202 through an interface, such as described in FIG. 7. If the user 202 designated an account for the account selection pool and provides account information in an interface, such as described in FIG. 7, the account may then be available for recommendation for the transaction. In one embodiment, the accounts in the account selection pool may be provided from a financial institution. If the user 202 has prior accounts with the financial institution, the financial institution may recognize the accounts and include them among the accounts in the selection pool. Thereafter, the financial institution may continually add additional accounts not already included in the selection pool to the pool of available accounts at a later date. For example, the user 202 may make a transaction using an account, such as a mobile wallet, a credit card, or other payment system that not linked to a specific account in the account selection pool. The financial institution server 208, may determine that the account is not a part of the account selection pool. The account that the user 202 used for the transaction that is not part of the user's account selection pool, the financial institution server 208 may add the account to the selection pool.

The account selection pool may be populated with several different types of accounts available to a user 202. In some embodiments, the payment accounts could include a single account. In some embodiments, the payment accounts could include a plurality of accounts. For example, as illustrated in FIG. 6, the user in this example has credit card 1 607, credit card 2 608, credit card 3 609, retailer credit card 1 610, retailer credit card 2 612, debit card 1 613, debit card 2 614, line of credit (LOC) 615, and a home equity line of credit (HELOC) 616.

In some embodiments, the financial institution may provide the accounts of the account selection pool. In other embodiments, the user 202 may provide the accounts for the account selection pool. One such way a user 202 may provide the accounts for the selection pool is by providing accounts via an account interface.

FIG. 7 provides one embodiment of a payment account interface 702 that allows a user 202 to enroll into the payment account determination program. The financial institution server 208 receives a request from a user 202 to set up the account selection pool. If the user 202 has not already enrolled, the financial institution server 208 may prompt the user 202 to create a new account. As illustrated in the security section 704, the user 202 creates a user name 706 and password 708 for a new account or otherwise logs into the user's account selection pool if the user 202 has previously set up a pool. For example, illustrated in FIG. 7 is a payment account interface 702 that allows a user 202 to create a log-in name and password to set up an account selection pool. In some embodiments, the payment account interface 702 requires entering information for security reasons 704. At this point, the user 202 may enter a user name 706, a password 708, and a security question 710. If the user name 706, password 708, and security question 710 are satisfactory, the interface prompts the user to the next step in the process. For example, if the user name 706 is being used by a current user, the new user will be prompted to create a different user name 706. In some embodiments, the user may simply enroll in the account selection pool through the user's online banking application. In some embodiments, the interface described herein may be accessed through the object recognition application 325 and/or the AR presentment application 321 using a mobile device 204.

The user 202 may provide information regarding the payment accounts available to him. The types of payment accounts available to the user 202 may include any account the user 202 may use to make a transaction. These accounts may include cash accounts, checking account, a plurality of credit cards or debit cards, a plurality of retailer cards, a plurality of lines of credit, a plurality of gift cards, etc. In the add accounts section 712 of the payment account interface 702, the user 202 can select the type of account 714 from a menu. The account selections include a credit card 718, a debit card 720, a retail card 722, a line of credit (LOC) 724, or a selection to create an account 726, to name a few. In other embodiments, other accounts may be added to the account selection pool. In one embodiment, the account may be with the financial institution. In one embodiment, the account may be with other financial institutions. In one embodiment, the account may be with an account providing business. The create an account selection 726 allows a user 202 to create an account that is not specifically mentioned in the select account type 714 menu. Once a type of account is selected 714, information regarding that account may be inputted in the account information section 716 in order to allow the financial institution to identify the account. In some embodiments, the accounts that can be added to the account selection pool are all issued by the user's primary financial institution. In other embodiments, the accounts added to the account selection pool may be issued by multiple businesses. The businesses could be any company that provides accounts such as credit cards, retail store cards, or other types of accounts such as lines of credit. For example, the user 202 can add an account that is not issued by the user's primary financial institution, such as a credit card account issued by a specific retailer or a secondary financial institution. In such embodiments, the user 202 may need to provide account information in the account information section 716, so that the primary financial institution can access information regarding the account at the secondary financial institution or other business. In some embodiments, the account information section 716 may include a bank section 728, an account number section 730, the expiration date section 732, and the routing number section 734 in order to add accounts to the account selection pool. In some embodiments, a user name 706 and password 708 may be entered to allow the primary financial institution to access account information located at the other businesses. Once the information in the account information section 716 is added, the user 202 may select to add that account to the account selection pool.

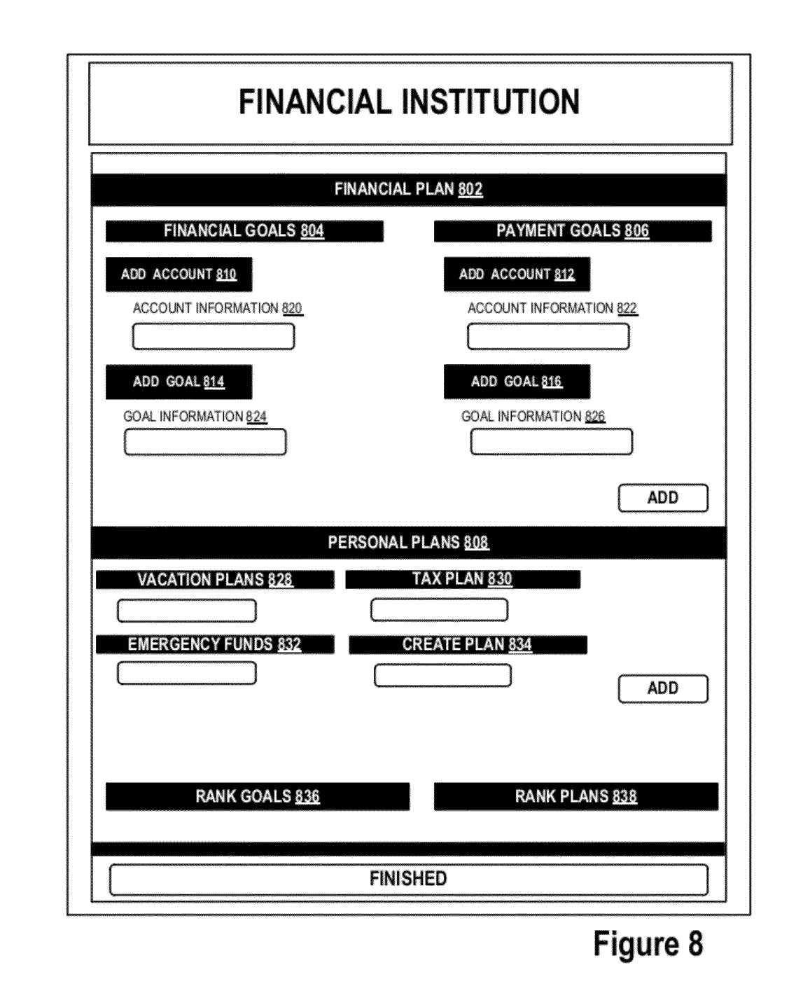

The user 202 may decide to continue and set up his personal financial plans. The payment account interface 702 may provide an add information section 736 for adding additional information. In the add information section 736, the user 202 may select the financial plans 738 which will provide the user 202 with a financial plan interface 802, as illustrated in FIG. 8. The user may also select to edit the financial institution considerations at section 742. Once the user 202 has completed using the payment account interface 702 he may select the finished section 750 to save the user data.

As illustrated in block 618 of FIG. 6, the next step in analyzing the information for a recommended appropriate payment account 512 is to identify the financial institution considerations. Financial institution considerations are criteria that the financial institution has in place or inputted by the user 202 to prevent overdraft charges, unwanted expenses, or identify user 202 spending trends with respect to the user's accounts. The financial institution considerations examined include the user's transaction history 619, the funds available in the payment accounts 620, the true cost of credit 621, and the impact on user's budget 617. With respect to the transaction history analysis, user transaction history may include a review of previous transactions a user 202 made at various merchants in order to determine the payment account the user 202 typically uses for the merchants. For example, the user 202 may purchase office supplies from the same merchant using a card that provides two percent cash back on office supplies. The system may use this information when determining the appropriate payment account to use in future transactions. For example, the system may determine that another card listed in the payment determination account, or another card that the user was recently issued, provides three percent cash back on purchases for office supplies. In such cases, the financial institution application 224 may suggest using the card that pays three percent cash back in future transactions for office supplies.

With respect to an account status inquiry of payment accounts, the financial institution application 224 may ensure that funds are available in the respective account to process the transaction. In some embodiments, an account status inquiry of payment accounts may ensure the credit limit for an account has not yet been reached. For example, if the user 202 previously made a large transaction prior to the current transaction being made, the account status inquiry may ensure that the transaction being made is not applied to an account that does not have the required funds, even if the account would provide the best promotional benefit to the user 202. In this way, it may be ensured that over-drafting the account will not occur due to the selection of a payment account with the best promotions.

With respect to the true cost of credit 621, the financial institution application 224 may calculate the true cost of credit if the user wishes to purchase a product that may take financing. The true cost of credit may include the required payments for purchase, the number of payments, the length of time payments may need to be made, the total cost of the product (including interest over the period of the loan), and the effect on the user's financial plans if the purchase is made.

With respect to the impact on user's budget 617, the financial institution application 224 may provide the user 202 with an indication as to how the purchase may impact the user's budget. For example, the user 202 may be saving a specific amount of money to use for a vacation in three months. The impact on user's budget 617 may provide the user 202 the information about the extent to which purchasing a new computer will effect his planned savings for a vacation, thus not having the specific amount saved for the vacation within the three month period.

As illustrated in block 622 of FIG. 6, the next step in analyzing the information for a recommended appropriate payment account 512 is to identify the financial plans of the user. Financial plans may include the user's financial goals 624, such as savings goals 626 and retirement goals 628; payment strategies 630, such as mortgage repayment 632 and loan repayment 634; and personal planning 636, such as vacation plans 638, job loss 640, emergency savings 642, and tax strategies 643.

The financial plans of the user 202 may help the financial institution application 224 provide a recommendation for a payment account to use for a transaction, based on the financial goals, payment strategies, and personal planning of the user 202. Financial goals may include savings goals 626 such as saving for a child's college, making an investment, saving to reach a specific amount, or saving for retirement 628. In some embodiments, a user 202 may have multiple savings goals, of which some may be more important than others to the user 202 at a particular time. Payment strategies may include loan repayment, such as repaying a student loan, a car loan, a personal bank loan, etc. Payment strategies may also include paying off debt, such as mortgage repayment, credit card debt repayment, or personal debt repayment. Personal planning 636 may include vacation planning 638, job loss planning 640, emergency planning 642, social networking data, and/or tax planning 643. Vacation planning 638 may include a user 202 saving for airfare, lodging, or other travel expenses. Job loss planning 640 allows the user 202 to direct the payment determination account to allocate financial transaction requests to accounts to maximize finances in case of a situation of unemployment. Emergency planning 642 allows the user 202 to direct the system to allocate transaction requests to accounts to maximize available financial resources to use in case of an emergency situation. Tax planning 643 allows the user 202 to direct the payment determination account to allocate transaction requests to accounts to utilize tax planning strategies set by the user 202.

The user 202 may input financial plans via a financial plan interface 802, as illustrated in FIG. 8. The financial plan interface 802 includes a section for financial goals. In the financial goals section 804, the user 202 has an option of adding an account to a list of financial goals that can be associated with transactions being made by the user 202 in an add account section 810. For example, the user 202 may add a savings account to the financial goals to which the user wants to apply cash back rewards. Cash back rewards may offer a percent of cash back to the user 202 for every purchase made using the card. In some embodiments, the user 202 may add account information, such as but not limited to the account number, financial institution at which the account is located, routing and transit number, etc. in the account information section 820. The financial goal section 804 may also include an add goal section 814 to add a goal to the associated account. In the add goal section 814, the user 202 may add any goal he wishes to obtain in relation to the add account section 810 in the goal information section 824. For example, the user 202 may want to reach two thousand dollars ($2,000) in a savings account added to the financial plan interface 802. In this way, the financial institution application 224 may recommend payment accounts to use in user transactions that provide the greatest cash back bonuses, which can be applied in some embodiments, directly to the savings account. Once the add account section 810 and/or the add goal section 814 are filled in, the user 202 may select the add button to save the financial goals 804 the user 202 inputted.

In another example, the user 202 may have an investment account that the user 202 may have a goal to reach twenty thousand dollars ($20,000) in the account. The user 202 may include the investment account in the add account section 810 and provide the goal in the add goal section 814. The financial institution application 224 may analyze a transaction to see if the transaction would produce more savings in a savings account or more savings in the investment account (e.g., based on the rates of return of both accounts) when determining where to apply a cash back bonus. In other embodiments, the financial institution application 224 may also determine to use a credit card or debit card depending on the transaction being made. For example, the credit card may provide a larger cash back bonus on a retail store purchase, while a debit card may provide a better cash back bonus on a grocery store purchase. The financial institution application 224 determines the type of transaction and applies the proper account to the transaction based on which card provides more cash to apply to the savings account or investment account to reach the user's financial goals.

In some embodiments of the invention, payment goals may also be included in the financial plan interface 802. Payment goals may include loan repayment options, credit card repayment options, and/or mortgage repayment options. For example, the financial plan interface 802 includes a payment goals section 806 for adding payment goals. In the payment goals section 806, the user 202 has an option of adding an account in an add account section 812 in the sale or similar way as previously described for adding a financial goal in the financial goal section 804 by adding account information in the add account information section 810. The payment goals section 806 also includes an add goal section 816 to add a goal to the payment account, which may be added in the same or similar way as previously described for adding a financial goal. In the add goal section 816, the user 202 may add any goal he wishes to obtain in relation to the added payment account by providing in the add goal information section 826. Once the add account section 812 and/or the add goal section 816 are populated, the user 202 may select to add the payment goals the user 202 inputted. For example, the user 202 may have student loans, a car loan, and a mortgage to repay. Therefore, the user 202 may include these accounts as payment goals 806. In this way, the financial institution application 224 can direct the cash back savings from various transactions to the specific payment goals entered by the user 202.

FIG. 8 may also includes a rank goals section 836. The rank goals section 836 allows a user 202 to rank the importance of reaching the goal such as the financial goal or payment goal. The ranking provides a selection box to add a numerical value to each of the goals, or other ranking or rating indicator. For example, the user 202 that had student loans, a car loan, and a mortgage to repay may want to focus his repayments to the loan having the highest interest rates. Therefore, the user 202 may rank the highest interest rate loan as the most important goal in his financial plan. In some embodiments, the ranking includes the accounts that were added from the financial goals section 804 and the payment goals section 806. In other embodiments the financial goals section 804 and the payment goals section 806 may be ranked separately or have separate interfaces for each type of goal. Once ranking is complete, the user 202 may update the selections or changes by selecting the finished button to save the changes to the financial plan.

As further illustrated in FIG. 8, the user 202 may select from several personal plan options, in the personal plan section 808, including vacation plans, tax plans, emergency funds, and/or create a plan in a vacation plans section 828, a tax plan section 830, an emergency funds section 832, and/or a create a plan section 834, respectively. Once the user 202 has selected the desired plan, the user 202 may choose to add the selected plan to incorporate into the recommended payment account selection. After the user 202 adds a personal plan or selects a personal plan for editing, the user 202 can set goals on the limits (not illustrated) associated with the personal plan. For example, in one embodiment, the user 202 may select a vacation goal plan that the user 202 wants to save as many miles points as possible to reach twenty thousand (20,000) points for a free vacation. In this way, the financial institution application 224 may determine the payment accounts from the account selection pool that result in the accrual of the most mileage points. Thus, the financial institution application 224 considers this personal plan, and may recommend the payment accounts that receive the most mileage points. In other embodiments, the user 202 may direct the financial institution application 224 to recommend a payment account associated with providing the most frequent flyer miles, if the user 202 is trying to plan for a trip. The user 202 may also want to request that the financial institution application 224 maximize cash back bonuses in case of an emergency.

In some embodiments, after the personal plans have been selected, the user 202 may wish to rank the personal plans in the rank plans section 838. In one embodiment, the plans may be ranked or rated in the same or similar way as previously discussed for ranking or rating the financial plans.

Ranking the personal plans, as well as financial plans as previously discussed, may include a numerical ranking system or other ranking system that allows the user 202 to rank the plans in order to achieve the goals that the user 202 has set for each type of plan. For example, in one embodiment, the plans may be ranked from first to last, in which case the financial institution application 224 may recommend the payment account that will reach the goals of the plan in the order that they are ranked. In other embodiments, the user 202 may assign a weighted value to each of the plans. In this way, the financial institution application 224 may recommend the payment account in order to apply the promotions to each of the goals of the plan in accordance to the weighted distributions. In still other embodiments, the user 202 may want to maximize the promotions for all of the plans. In this way, financial institution application 224 may recommend the payment account in each of the transactions that maximizes the equivalent cash value that can be applied to one or more transactions. Once the user 202 is finished using the financial plans interface 802 the user 202 may select the finish button in order to save the data.

After the financial institution application 224 or the mobile device 204 examines the criteria, in block 646 of FIG. 6, the recommended appropriate payment account for the images in the environment may be provided to the user via a mobile device 204. In some embodiments, the recommended appropriate payment account may be provided in real-time in the environment 250 by the indicator 230. In some embodiments, the recommended appropriate payment account may be provided to the user 202 after the user 202 selects the indicator 230.

This is further detailed in FIG. 5, once the information is analyzed for recommendation of an appropriate payment account in block 512, in decision block 514, a determination is made as to whether the mobile device 204 is still capturing video stream of a product, service, and/or object. If no video stream is being captured then no indicator is presented in block 516 via the AR presentment application 321. If a video stream is still being capture, then in block 518 indicators are continuing to be presented. The indicators are associated with a product and/or service that the user 202 may visualize in an environment 250 via the AR presentment application 321. In some embodiments, the user 202 may be provided a recommendation for a payment account prior to selecting an indication. In some embodiments, as illustrated in block 520, a user 202 may receive a recommendation for a payment account after the user 202 selects the indicator.

If the user 202 selects the indicator in block 520, the user 202 is provided the financial institution's recommendation for a payment account for the object indicator selected. The recommendation is based on the several criteria, including the transaction, the types of payment accounts available to the user, the user's financial plans, and/or financial institution considerations, as explained in detail above. In some embodiments, the recommended payment account is provided upon selection of the indicator. In some embodiments, special offers for the product are provided upon selection of the indicator. In some embodiments, financing for the product may be provided upon selection of the indicator.

Special offers for the product may include promotions, coupons, gift certificates, discounts, etc. Special offers may increase if the purchase of the product is made within a specific time period of using the system. Special offers may further be provided if the user 202 opens an account with the financial institution within a specific time period before and/or after the purchase of the product. For example, a user 202 may wish to purchase a computer from a retail store. The retail store may be a commercial partner of the financial institution; therefore the financial institution may provide the user 202 a special offer for the computer if it is purchased at that retail store. The special offer may be available to the user 202 if the user 202 selects the indicator in the augmented reality environment.

Financing for the purchase of the product may also be available to the user 202 if the user selects the indicator. Financing may be provided and approved by the financial institution in real-time, such that the user 202 may not have to wait to purchase a product to ensure financing from a financial institution. For example, a user 202 may wish to purchase a vehicle using a loan from a financial institution. If the user 202 selects the indicator associated with the vehicle he wishes to purchase, the financial institution may approve him for a loan at that point. The rates, variables, and conditions for the loan will be provided to the user 202. The user 202 may also provide the data to the car dealer, so that the car dealer may have knowledge of the approved loan. Therefore, expediting the user's purchase of products that may require financing.

As further illustrated in FIG. 5 at block 522 a user 202 may purchase a product based on the recommendation. In some embodiments, the user 202 may purchase the product using the account recommended. In some embodiments, the user 202 may purchase the product using an account other than the one recommended. In still other embodiments the user 202 may not purchase the product.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, etc.), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, etc.) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

Thus, methods, systems, computer programs and the like have been disclosed that provide for using real-time video analysis, such as AR or the like to assist the user of mobile devices with commerce activities. Through the use real-time vision object recognition objects, logos, artwork, products, locations and other features that can be recognized in the real-time video stream can be matched to data associated with such to assist the user with commerce activity. The commerce activity may include, but is not limited to; conducting a transaction, providing information about a product/service, providing rewards based information, providing user-specific offers, or the like. In specific embodiments, the data that matched to the images in the real-time video stream is specific to financial institutions, such as user financial behavior history, user purchase power/transaction history and the like. In this regard, many of the embodiments herein disclosed leverage financial institution data, which is uniquely specific to financial institution, in providing information to mobile devices users in connection with real-time video stream analysis.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

The systems, methods, computer program products, etc. described herein, may be utilized or combined with any other suitable AR-related application. Non-limiting examples of other suitable AR-related applications include those described in the following U.S. Provisional Patent Applications, the entirety of each of which is incorporated herein by reference:

| U.S. Provisional | | |
|---|---|---|
| Ser. No. | Filed On | Title |
| 61/450,213 | Mar. 8, 2011 | Real-Time Video Image Analysis Applications |
| | | for Commerce Activity |
| 61/478,409 | Apr. 22, 2011 | Presenting Offers on a Mobile Communication |
| | | Device |
| 61/478,412 | Apr. 22, 2011 | Real-Time Video Analysis for Reward Offers |
| 61/478,394 | Apr. 22, 2011 | Real-Time Video Image Analysis for |
| | | Providing Targeted Offers |
| 61/478,399 | Apr. 22, 2011 | Real-Time Analysis Involving Real Estate Listings |
| 61/478,405 | Apr. 22, 2011 | Presenting Investment-Related Information |
| | | on a Mobile Communication Device |
| 61/478,393 | Apr. 22, 2011 | Real-Time Image Analysis for Medical |
| | | Savings Plans |
| 61/478,397 | Apr. 22, 2011 | Providing Data Associated With |
| | | Relationships Between Individuals and |
| | | Images |
| 61/478,408 | Apr. 22, 2011 | Identifying Predetermined Objects in a Video |
| | | Stream Captured by a Mobile Device |
| 61/478,400 | Apr. 22, 2011 | Real-Time Image Analysis for Providing |
| | | Health Related Information |
| 61/478,411 | Apr. 22, 2011 | Retrieving Product Information From |
| | | Embedded Sensors Via Mobile Device Video |
| | | Analysis |
| 61/478,403 | Apr. 22, 2011 | Providing Social Impact Information |
| | | Associated With Identified Products or |
| | | Businesses |
| 61/478,407 | Apr. 22, 2011 | Providing Information Associated With an |
| | | Identified Representation of an Object |
| 61/478,415 | Apr. 22, 2011 | Providing Location Identification of |
| | | Associated Individuals Based on Identifying |
| | | the Individuals in Conjunction With a Live |
| | | Video Stream |
| 61/478,419 | Apr. 22, 2011 | Vehicle Recognition |
| 61/478,417 | Apr. 22, 2011 | Collective Network of Augmented Reality |
| | | Users |
| 61/508,985 | Jul. 18, 2011 | Providing Information Regarding Medical |
| | | Conditions |
| 61/508,946 | Jul. 18, 2011 | Dynamically Identifying Individuals From a |
| | | Captured Image |
| 61/508,980 | Jul. 18, 2011 | Providing Affinity Program Information |
| 61/508,821 | Jul. 18, 2011 | Providing Information Regarding Sports |
| | | Movements |
| 61/508,850 | Jul. 18, 2011 | Assessing Environmental Characteristics in a |
| | | Video Stream Captured by a Mobile Device |
| 61/508,966 | Jul. 18, 2011 | Real-Time Video Image Analysis for |
| | | Providing Virtual Landscaping |
| 61/508,969 | Jul. 18, 2011 | Real-Time Video Image Analysis for |
| | | Providing Virtual Interior Design |
| 61/508,971 | Jul. 18, 2011 | Real-Time Video Image Analysis for |
| | | Providing Deepening Customer Value |
| 61/508,764 | Jul. 18, 2011 | Conducting Financial Transactions Based on |
| | | Identification of Individuals in an |
| | | Augmented Reality Environment |
| 61/508,973 | Jul. 18, 2011 | Real-Time Video Image Analysis for |
| | | Providing Security |
| 61/508,976 | Jul. 18, 2011 | Providing Retail Shopping Assistance |
| 61/508,944 | Jul. 18, 2011 | Recognizing Financial Document Images |

What is claimed is:

1. A method of determining an appropriate payment account for a transaction comprising:
receiving information about a plurality of payment accounts available to a user;
determining promotions associated with each of the plurality of payment accounts, wherein the promotions are for purchases of products using the payment account;
identifying, via a computer device processor, one or more products proximate in location to a mobile device;
determining the appropriate payment account for use in payment for the identified products, wherein the appropriate payment account is based at least in part on the determined promotions associated with each of the plurality of payment accounts, wherein the appropriate payment account provides the most beneficial promotion to the user at that time for the purchase of the one or more products; and
presenting, via a mobile device, an indicator associated with the product, wherein the indication provides a payment account recommendation, wherein the payment account recommendation is the determined appropriate payment account.

2. The method of claim 1, wherein identifying one or more products further comprises capturing, via the mobile device, images of the one or more products.

3. The method of claim 2, wherein capturing images further comprises implementing, via a computer device processor, object recognition processing to identify one or more images that correspond to one or more products.

4. The method of claim 1, wherein identifying one or more products further comprises capturing a tag located on or proximate to one or more of the products and reading the tag to identify the product.

5. The method of claim 1, wherein identifying one or more products further comprises capturing real-time video of the one or more products product.

6. The method of claim 1, wherein determining a payment account for a product is based at least in part on a financial plan of the user, wherein the financial plan of the user further comprises the most beneficial promotion to the user at that the time of the transaction.

7. The method of claim 6, wherein the financial plan comprises at least one of financial goals, payment goals, and personal plans.

8. The method of claim 1, further comprising presenting an indicator on the mobile device, where the indicator is associated with the one or more products displayed on the mobile device.

9. The method of claim 1, wherein presenting an indicator associated with the one or more product comprises superimposing the indicator over real-time video that is captured by the mobile device.

10. The method of claim 1, wherein the indicator is selectable by the user.

11. The method of claim 1, wherein the indicator, upon being selected, provides a payment account recommendation based at least in part on types of payment accounts available to the user.

12. The method of claim 1, wherein the indicator, upon being selected, provides a payment account recommendation based at least in part on financial institution considerations.

13. The method of claim 1, wherein the indicator, upon being selected, provides a payment account recommendation based at least in part on financial plans of the user.

14. The method of claim 1, wherein the indicator, upon being selected, triggers the system to provide financing to the user for purchasing the product.

15. A system for determining an appropriate payment account for a transaction, the system comprising:
a memory device;
a communication device;
a processing device operatively coupled to the memory device and the communication device, wherein the processing device is configured to execute computer-readable program code to:
receive information about a plurality of payment accounts available to a user;
determine promotions associated with each of the plurality of payment accounts, wherein the promotions are for purchases of products using the payment account;
identify one or more products proximate in location to a mobile device;
determine the appropriate payment account for use in payment for the identified products, wherein the appropriate payment account is based at least in part on the determined promotions associated with each of the plurality of payment accounts, wherein the appropriate payment account provides the most beneficial promotion to the user at that time for the purchase of the one or more products; and
present, via a mobile device, an indicator associated with the product, wherein the indication provides a payment account recommendation, wherein the payment account recommendation is the determined appropriate payment account.

16. The system of claim 15, wherein identifying one or more products further comprises capturing, via the mobile device, images of the one or more products.

17. The system of claim 16, wherein capturing images further comprises implementing, via a computer device processor, object recognition processing to identify one or more images that correspond to one or more products.

18. The system of claim 15, wherein identifying one or more products further comprises capturing a tag located on or proximate to one or more of the products and reading the tag to identify the product.

19. The system of claim 15, wherein identifying one or more products further comprises capturing real-time video of the one or more products product.

20. The system of claim 15, wherein determining a payment account for a product is based at least in part on a financial plan of the user, wherein the financial plan of the user further comprises the most beneficial promotion to the user at that the time of the transaction.

21. The system of claim 20, wherein the financial plan comprises at least one of financial goals, payment goals, and personal plans.

22. The system of claim 15, further comprising presenting an indicator on the mobile device, where the indicator is associated with the one or more products displayed on the mobile device.

23. The system of claim 15, wherein presenting an indicator associated with the one or more product comprises superimposing the indicator over real-time video that is captured by the mobile device.

24. The system of claim 15, wherein the indicator is selectable by the user.

25. The system of claim 15, wherein the indicator, upon being selected, provides a payment account recommendation based at least in part on types of payment accounts available to the user.

26. The system of claim 15, wherein the indicator, upon being selected, provides a payment account recommendation based at least in part on financial institution considerations.

27. The system of claim 15, wherein the indicator, upon being selected, provides a payment account recommendation based at least in part on financial plans of the user.

28. The system of claim 15, wherein the indicator, upon being selected, triggers the system to provide financing to the user for purchasing the product.

29. A computer program product, the computer program product comprising at least one non-transitory computer-readable medium having computer-readable program code portions embodied therein, the computer-readable program code portions comprising:
an executable portion configured for receiving information about a plurality of payment accounts available to a user;
an executable portion configured for determining promotions associated with each of the plurality of payment accounts, wherein the promotions are for purchases of products using the payment account;
an executable portion configured for identifying one or more products proximate in location to a mobile device;
an executable portion configured for determining the appropriate payment account for use in payment for the identified products, wherein the appropriate payment account is based at least in part on the determined promotions associated with each of the plurality of payment accounts, wherein the appropriate payment account provides the most beneficial promotion to the user at that time for the purchase of the one or more products; and
an executable portion configured for presenting, via a mobile device, an indicator associated with the product, wherein the indication provides a payment account recommendation, wherein the payment account recommendation is the determined appropriate payment account.

30. The computer program product of claim 29, wherein identifying one or more products further comprises capturing, via the mobile device, images of the one or more products.

31. The computer program product of claim 30, wherein capturing images further comprises implementing, via a computer device processor, object recognition processing to identify one or more images that correspond to one or more products.

32. The computer program product of claim 29, wherein identifying one or more products further comprises capturing a tag located on or proximate to one or more of the products and reading the tag to identify the product.

33. The computer program product of claim 29, wherein identifying one or more products further comprises capturing real-time video of the one or more products product.

34. The computer program product of claim 29, wherein determining a payment account for a product is based at least in part on a financial plan of the user, wherein the financial plan of the user further comprises the most beneficial promotion to the user at that the time of the transaction.

35. The computer program product of claim 34, wherein the financial plan comprises at least one of financial goals, payment goals, and personal plans.

36. The method of claim 1, further comprising presenting an indicator on the mobile device, where the indicator is associated with the one or more products displayed on the mobile device.

37. The computer program product of claim 29, wherein presenting an indicator associated with the one or more product comprises superimposing the indicator over real-time video that is captured by the mobile device.

38. The computer program product of claim 29, wherein the indicator is selectable by the user.

39. The computer program product of claim 29, wherein the indicator, upon being selected, provides a payment account recommendation based at least in part on types of payment accounts available to the user.

40. The computer program product of claim 29, wherein the indicator, upon being selected, provides a payment account recommendation based at least in part on financial institution considerations.

41. The computer program product of claim 29, wherein the indicator, upon being selected, provides a payment account recommendation based at least in part on financial plans of the user.

42. The computer program product of claim 29, wherein the indicator, upon being selected, triggers the system to provide financing to the user for purchasing the product.
